(19) United States
(12) Patent Application Publication
(10) Pub. No.: US 2013/0141803 A1
(43) Pub. Date: Jun. 6, 2013

(54) APPARATUS FOR COLLECTION OF CATHODOLUMINESCENCE SIGNALS

(71) Applicants: Simon Galloway, Oxon (GB); David J. Stowe, Berkshire (GB); Richard Vince, Berkshire (GB); Levi Beeching, Kent (GB); John Blackwell, Ely (GB)

(72) Inventors: Simon Galloway, Oxon (GB); David J. Stowe, Berkshire (GB); Richard Vince, Berkshire (GB); Levi Beeching, Kent (GB); John Blackwell, Ely (GB)

(73) Assignee: GATAN, INC., Warrendale, PA (US)

(21) Appl. No.: 13/309,026

(22) Filed: Dec. 1, 2011

(51) Int. Cl. G02B 17/08; G02B 5/10

(52) U.S. Cl. 359/726; 359/868; 359/850

(57) ABSTRACT

A side entry TEM holder incorporates a miniature tilted off axis elliptical mirror to collect cathodoluminescence from the specimen and couple it efficiently into a tilted fiber optic integrated into the holder. The design is compatible with the cryogenic operation of the holder. TEM specimens are partially transparent to the electron beam, and so light can be emitted above and below the specimen. The same principle of off-axis mirror and tilted fiber can be utilized to collect light from above and below the specimen yet fit into the very confined space required by insertion through the goniometer and for operation between narrow gap pole pieces. With a dual system, the emission of light from above the specimen can be compared to that from below thereby enhancing the versatility of the analytical technique.

### FIELD OF THE INVENTION

This invention relates to the field of electron microscopy and in particular to the collection cathodoluminescence signals.

### BACKGROUND OF THE INVENTION

Cathodoluminescence (CL) is more established as a technique in the scanning electron microscope (SEM) because of the larger signal and easier access to the specimen with regard to light collection optics. CL is of interest in the TEM (in STEM mode) because of the possibility of higher magnification work, higher kV studies, access to other complimentary analysis techniques, e.g. diffraction, EELS.

Historically, efficient light collection of cathodoluminescence (CL) in a TEM has been achieved using off-axis parabolic mirrors which provide direct optical coupling through a side vacuum window. When the specimen is held at the focal point of these mirrors, light is then collimated and can be coupled to other transmission or detection apparatuses. However, this approach is restricted to TEM microscopes with a wide pole piece gap (e.g. >6 mm) and with an appropriate additional port to position the mirror above the specimen.

Cathodoluminescence can be weak in a TEM because the volume stimulated by the electron beam is small. This is because the specimen is normally thin enough to be partially transparent to electrons at the desired working accelerating voltage. Cathodoluminescence is normally analyzed in terms of size of signal (panchromatic imaging), size of a specific bandpass, (monochromatic or filtered imaging), and spectroscopic mapping. It can also be analyzed as a function of time, from picoseconds resolution to evolution over some hours. The efficiency of cathodoluminescene varies very significantly depending on specimen type, temperature, thickness and injection conditions. Efficient light collection is useful and sometimes essential to perform an experiment, especially if the signal must be measured simultaneously with other analytical measurements.

Some TEM pole pieces and side entry holders provide hard restrictions on the available space to employ collection and transmission optics. A side entry Transmission Electron Microscope (TEM) holder holds a specimen on a goniometer in a tightly restricted volume. The restriction is given by the need to insert through the vacuum seal of the goniometer and by the pole piece gap of the TEM. In practice this means that almost all known TEM-CL solutions utilizing some form of collection optics are restricted to wide pole piece gap instruments (upper or lower gaps >4 mm). The use of a wide pole piece gaps compromises the performance of the TEM when used for other analytical techniques. It is estimated that greater than 80% of TEMs installed worldwide are unsuitable for known TEM-CL technology due to the narrow pole pieces they employ. Thus an need exists for a solution that overcomes the space restrictions when employing collection optics.

### SUMMARY OF THE INVENTION

In an embodiment, there is disclosed an apparatus for collection of cathodoluminescence from a sample under irradiation by electrons in an electron microscope. The apparatus includes sample carrier for a sample having a sample plane; a light collection mirror; a fiber optic transmission cable having a face. The light collection mirror is a reflective ellipsoid surface situated to collect light from the sample. The ellipsoid surface comprising a portion of an ellipsoid. The ellipsoid has a first focal point at the sample and a second focal point as the fiber optic cable face. The ellipsoid has an axis between the focal points, with the axis being tilted with respect to the sample plane.

In a further embodiment, the face of said fiber optic transmission cable is tilted to optimize collection efficiency. In a further embodiment, the fiber optic transmission cable is a single silica core high numerical aperture fiber. In a further embodiment, the fiber optic transmission cable has a numerical aperture of about 0.37. In a further embodiment, the fiber optic transmission cable has a core size of approximately 0.4 mm.

In a further embodiment, the fiber optic transmission cable is stripped to achieve a bend for aligning its face for optimal collection efficiency. In a further embodiment, the ellipsoid mirror is made of rapidly solidified aluminum.

In a further embodiment, there is at least one lens between the fiber face and the ellipsoid mirror. In a further embodiment, there are two light collection mirrors and fiber optic cables, with the mirrors arranged to collect light from two sides of the sample.

In a further embodiment, the ellipsoid is tilted at an angle of approximately 10 degrees with respect to the sample plane.

In a further embodiment, the sample is irradiated by ions instead of electrons.

### DESCRIPTION OF THE DRAWINGS

The foregoing summary, as well as the following detailed description of the invention, will be better understood when read in conjunction with the appended drawings. For the purpose of illustrating the invention, there are shown in the drawings certain embodiments which are presently preferred. It should be understood, however, that the invention is not limited to the precise arrangements and instrumentalities shown.

FIG. 1 is a cross sectional drawing of an exemplary device for efficient collection of cathodoluminescence signals;

FIG. 1a is an enlarged view of the device of FIG. 1.

FIG. 2 is a cross sectional drawing of an exemplary tilted ellipsoid for use in the device of FIG. 1; and

FIG. 3 is a cross sectional drawing showing tilted ellipsoid mirrors, tilted fiber optic cables and a specimen.

### DETAILED DESCRIPTION

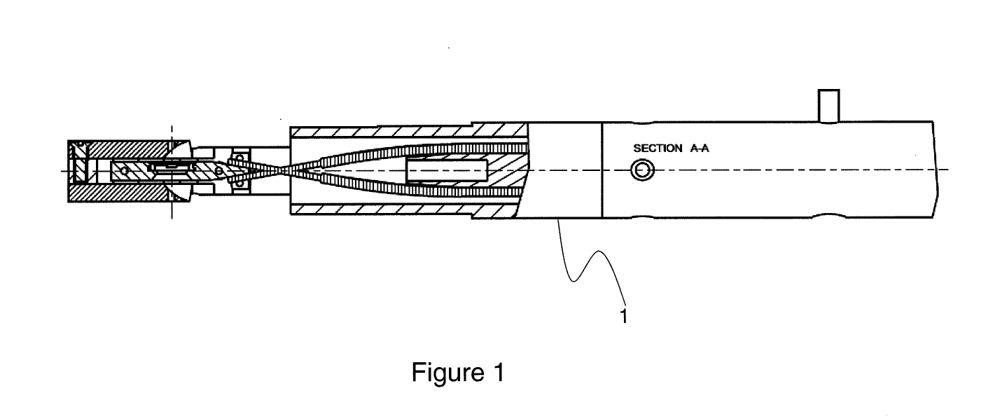

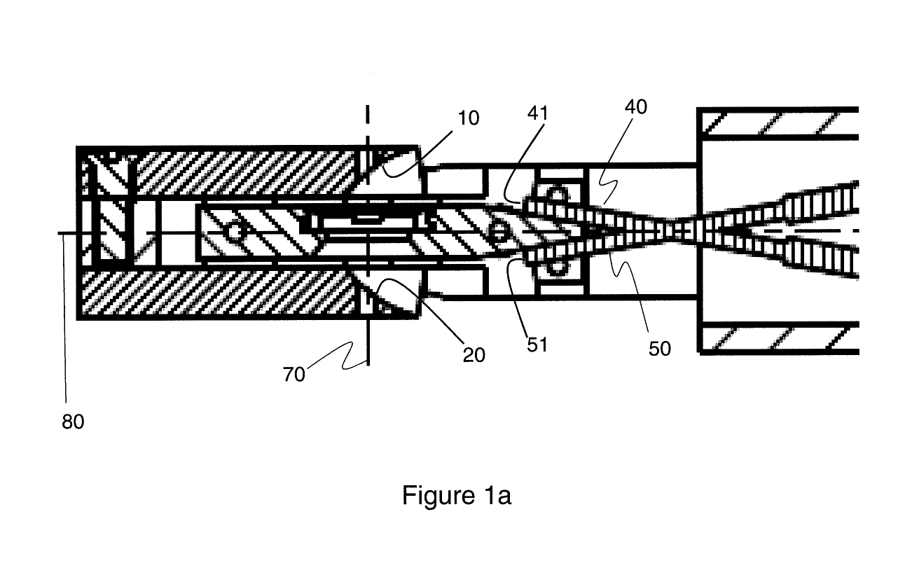

In an exemplary embodiment, and with reference to FIGS. 1 and 1a, collection mirrors 10, 20 attached to the end piece of a side entry holder 1 collect light from the region of the sample at the intersection of the holder center line 80 and the opening centerline 70 and transmit it to a suitable detection system external to the TEM via fiber optic cables 40, 50. The fiber optic cables have faces 41, 51 tilted for maximum collection of light.

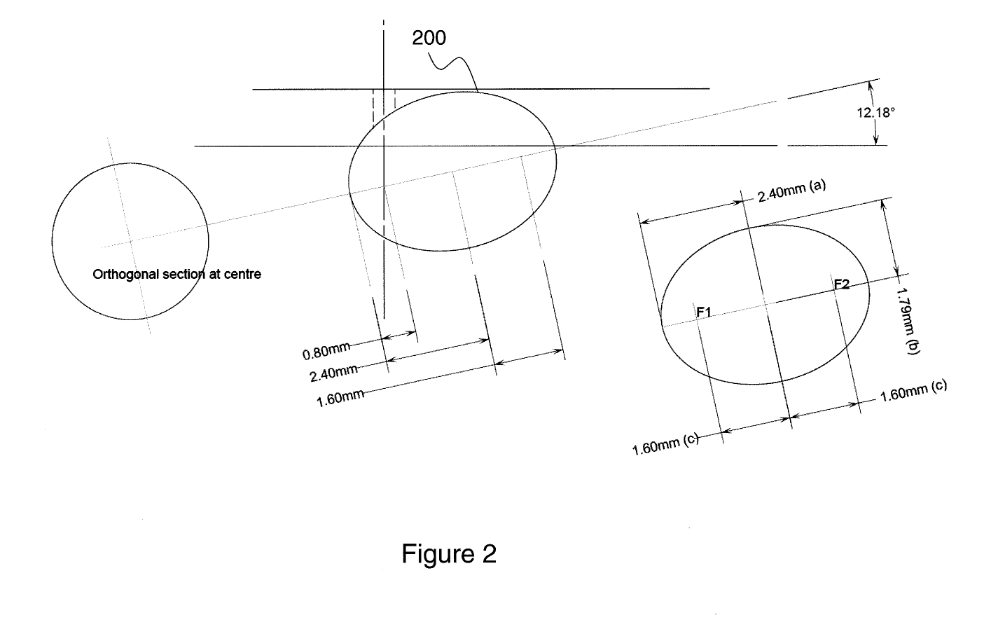

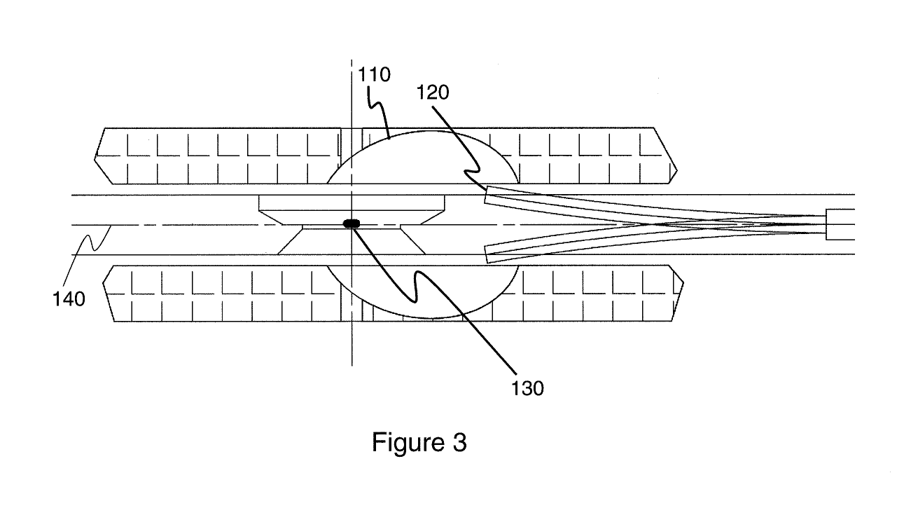

The operation of the collection mirrors is as follows. With reference to FIGS. 2 and 3, Elliptical mirrors have two foci F1, F2. High collection efficiency requires a large solid angle subtended by the elliptical mirror 110, whilst efficient light coupling into the fiber 120 requires matching the numerical aperture of both the fiber and the mirror. Such a design typically occupies too much height and will not fit into the available space.

Through diligent efforts, the inventors have found that space occupied by the mirrors can be reduced without sacrificing collection efficiency by tilting the collection optic ellipses, as shown in FIGS. 3 and 2 and optical fibers 120 with respect to the plane 140 of the holder 1. The tilting of this collection mirror ellipse with respect to the holder axis, is combined with the use of angled, high numerical aperture fibers. This affords the most compact design while maintaining high efficiency. The compact design allows light to be collected from above and below the specimen 30 simultaneously with the highest possible solid angle of collection. FIG. 2 shows an ellipsoid 200 tilted at 12.18 degrees off the horizontal plane. This is the tilt angle of the mirror in FIG. 3, which is a portion of the ellipse shown in FIG. 2. By comparing FIG. 2 with FIG. 3, it can be seen how efficient collection can be achieved with the specimen's region of interest at one focus and the fiber optic core at the other, where F1 falls at the specimen 130 and F2 is at the face 120 of fiber optic. If the ellipse and fiber were not tilted, then the solid angle of the mirror would need to be greatly diminished in order to fit it into the gap between the pole pieces and the collection efficiency would be greatly reduced.

An ellipsoid tilt angle of 10 degrees has been successfully applied in a further embodiment.

A fiber optic is a useful conduit for light in places of tight constraint, but also where thermal conductivity is important to control. With TEM holders, very small variations in temperature can cause drift which is seen in high magnification images. With care, fiber optics can be introduced into a holder operating at LN2 temperatures without the fiber causing thermal artifacts. As fiber optics are employed they do not impact the thermal stability of a holder. This therefore allows imaging and analysis at high magnification with the specimen held at cryogenic temperatures. (Room temperature or high temperature versions of the holder are also possible). As the light collection and transmission optics are built into the side entry holder the whole system is compact and the analytical equipment used to analyze the light can be a considerable distance away from the TEM column, e.g. in a neighboring room or building.

As light can be emitted from above and below the specimen, the specimen can be considered to provide a plane of symmetry. In some TEMs, there is some asymmetry in the space above and below the holder. If the light output above and below the specimen were equal, then the collection efficiency can be doubled with a symmetrical design that collects light from above and below. In cases with unequal light output above and below the specimen, collection efficiency is still increased.

Because of electron and optical considerations, the material for the reflective elliptical mirror must be of a non-magnetic conductive metal which can be manufactured to a precise mathematical shape. This is required to correctly reflect and focus light emitted from a region of interest on the specimen into the tilted fiber. In an embodiment, rapidly solidified aluminum is used for the mirrors because this material enables precision machining of miniature light collection optics.

The choice of fiber is important. In order to maximize both the field of view and collection efficiency, a single silica core fiber with a core of 0.4 mm is used with a multi mode NA of 0.37. A fiber of NA 0.22 is most commonly used in spectroscopy apparatus and this would be very inefficient by comparison. The silica core provides good spectral response over the range of wavelengths required for CL measurements.

In an exemplary embodiment, the inventors have manufactured and tested a design having a gap above the specimen of 2.25 mm and below the specimen of 2 mm. In this design similar opposing off-axis elliptical mirrors and tilted fibers collect light from above and below the specimen simultaneously. The smaller gap below restricts the volume and hence solid angle captured by this mirror, but there remains symmetry in the focusing optics. To achieve this the fibers are stripped to achieve the required bend radii at a compound bend close proximity cross over point as shown in FIG. 1.

For a holder equipped with 2 mirrors, then one mirror either above or below will need to be removable in order for the user to insert a specimen, normally held on a thin 3 mm grid. This invention provides access to the specimen with a removable mirror. In the case of a holder with only one mirror, the access can be designed to be on the other side of the specimen boat to the mirror. The mirror may be removed and re-installed with a high degree of reproducibility as the mirror component locates on the TEM holder

Using collection optics above and below and coupling into two different fibers allows users to differentiate the two signals. Also, this dual fiber approach allows users to inject light into their system using one or more fibers in order to check alignment, or perform experiments that involve optic injection of light.

While the embodiments described above refer to cathodoluminescence of a sample stimulated by irradiance by electrons in a TEM, the principles disclosed may be equally applied to other devices that cause a sample to emit light. One such example is devices that irradiate samples with ions. Other devices which produce light from a sample and have limited space will also benefit from the use of the tilted ellipsoid mirror and tilted fiber optic assembly described herein.

While the invention has been described in detail and with reference to specific examples thereof, it will be apparent to one skilled in the art that various changes and modifications can be made therein without departing from the spirit and scope thereof.

We claim:

1. An apparatus for collection of cathodoluminescence from a sample under irradiation by electrons in an electron microscope comprising:
a sample carrier for a sample having a sample plane;
a light collection mirror;
a fiber optic transmission cable having a face; wherein
said light collection mirror comprises a reflective ellipsoid surface situated to collect light from said sample, said ellipsoid surface comprising a portion of an ellipsoid, said ellipsoid having a first focal point at said sample and a second focal point as said fiber optic cable face;
said ellipsoid having an axis between said focal points, said axis being tilted with respect to said sample plane.

2. The apparatus of claim 1 wherein said face of said fiber optic transmission cable is tilted to optimize collection efficiency.

3. The apparatus of claim 1 wherein said fiber optic transmission cable is a single silica core high numerical aperture fiber.

4. The apparatus of claim 3, wherein said fiber optic transmission cable has a numerical aperture of about 0.37.

5. The apparatus of claim 3, wherein said fiber optic transmission cable has a core size of approximately 0.4 mm.

6. The apparatus of claim 1, wherein said fiber optic transmission cable is stripped to achieve a bend for aligning said face for optimal collection efficiency.

7. The apparatus of claim 1 wherein said mirror is made of rapidly solidified aluminum.

8. The apparatus of claim 1 further comprising a lens between said fiber face and said mirror.

9. The apparatus of claim 1, comprising two of said light collection mirrors and fiber optic cables, said mirrors arranged to collect light from two sides of the sample.

10. The apparatus of claim 1, wherein said ellipsoid being tilted at an angle of approximately 10 degrees with respect to said sample plane.

11. An apparatus for collection of cathodoluminescence from a sample under irradiation by ions comprising:
a sample carrier for a sample having a sample plane;
a light collection mirror;
a fiber optic transmission cable having a face; wherein
said light collection mirror comprises a reflective ellipsoid surface situated to collect light from said sample, said ellipsoid surface comprising a portion of an ellipsoid, said ellipsoid having a first focal point at said sample and a second focal point as said fiber optic cable face;
said ellipsoid having an axis between said focal points, said axis being tilted with respect to said sample plane.
